(19) United States
(12) Patent Application Publication
(10) Pub. No.: US 2020/0017808 A1
(43) Pub. Date: Jan. 16, 2020

(54) METHOD AND APPARATUS FOR PRODUCING AN ALCOHOLIC BEVERAGE

(71) Applicant: EBED Holdings Inc., Baden (CA)

(72) Inventor: Walter J. Bauer, Baden (CA)

(21) Appl. No.: 16/335,499

(22) PCT Filed: Sep. 28, 2017
(86) PCT No.: PCT/CA2017/051146

§ 371 Date: Mar. 21, 2019

Related U.S. Application Data
(60) Provisional application No. 62/400,905, filed on Sep. 28, 2016.

(51) Int. Cl. C12C 12/00; C12C 5/00; C12C 7/04; C12H 1/07; C13K 1/06; C12G 3/08

(52) U.S. Cl. CPC C12C 12/00; C12C 5/002; C12G 3/08; C12H 1/063; C13K 1/06; C12C 7/042

(57) ABSTRACT

The disclosure is directed at a method and apparatus for producing an alcoholic beverage. In the current disclosure, the method and apparatus include the use of a nanobubble solution, such as nanobubble water, in the production of the alcoholic beverage. A nanobubble solution is produced

### CROSS-REFERENCE TO OTHER APPLICATIONS

This is a formal application based on and claiming the benefit of U.S. Provisional Application No. 62/400,905 filed Sep. 28, 2016 which is hereby incorporated by reference.

### TECHNICAL FIELD

The disclosure is generally directed at alcoholic beverages and more specifically is directed at a method and apparatus for producing an alcoholic beverage.

### BACKGROUND

Beer making, or beer brewing, is a process that has been known for many years. The basic ingredients of beer are water; a starch source, such as malted barley, able to be fermented (converted into alcohol); a brewer's yeast to produce the fermentation; and a flavouring, such as hops, to offset the sweetness of the malt.

With many current beers, the typical brewing process results in an alcohol percentage of between 4.8% to 5.4%. This alcohol percentage reflects the amount of starch converted to alcohol in the process. While some brewers have been able to achieve higher alcohol percentages using various techniques, there is typically a higher cost to being able to achieve these percentages due to larger amounts of raw materials, longer time of production or the like.

Therefore, there is provided a method and system for producing an alcoholic beverage.

### SUMMARY

The disclosure is directed at a method of producing an alcoholic beverage. The method described provides a beverage which has a higher alcohol by volume percentage than current alcoholic beverages being produced using identical ingredients, processes and recipes. By generating a nanobubble solution, such as a nanobubble water, and substituting this into the alcoholic beverage production process, improvements to the resultant alcoholic beverage are realized.

In one aspect of the disclosure, use of the nanobubble solution, or nanobubble water, may also enhance sugar extraction from a starch source. An increased amount of sugar can be extracted compared with sugar extraction using regular water, and the sugar may be extracted in a shorter time frame. The extraction of more sugar from the starch source may enhance various properties and characteristics when the nanobubble water is used in the production of an alcoholic beverage.

In one aspect of the disclosure, there is provided a method of sugar extraction including heating up a nanobubble water solution and then mixing the heated nanobubble water solution with a starch source. The extracted sugar solution can then be further processed to retrieve the extracted sugar or the extracted sugar solution may be used as a liquid in further beverage preparation.

In another aspect of the disclosure, there is provided a method of producing an alcoholic beverage by using a nanobubble water instead of regular water during the production process.

In a further aspect of the disclosure, there is a method of producing a nanobubble water for use in the production of an alcoholic beverage or in sugar extraction.

In one aspect of the disclosure, there is provided a method of producing an alcoholic beverage including generating a nanobubble solution; mixing the nanobubble solution with a mash solution to produce a nanobubble and mash mixture; lautering the nanobubble and mash mixture to produce a wort; boiling the wort; fermenting the boiled wort; conditioning the fermented mixture; and filtering the conditioned mixture.

In another aspect, generating a nanonbubble solution includes passing a liquid through a nanobubble generating apparatus. In a further aspect, the liquid is water. In yet another aspect, the nanobubble solution is heated before mixing the nanobubble solution with the mash solution. In yet another aspect, the nanobubble and mash mixture is heated prior to lautering the wort. In another aspect, lautering includes separating grains from the wort.

In another aspect of the disclosure, there is provided an apparatus for producing an alcoholic beverage including a nanobubble solution producing apparatus; an apparatus for providing a mash solution; and a mixing vessel for mixing the nanobubble solution and the mash solution.

In a further aspect, the nanobubble solution producing apparatus includes a nanobubble generator. In another aspect, the nanobubble solution production apparatus further includes a liquid source connected to an inflow end of the nanobubble generator. In yet another aspect, the nanobubble solution production apparatus further includes a reservoir for collecting the nanobubble solution at an outflow end of the nanobubble generator. In yet a further aspect, the system includes a heating apparatus for heating the mixing vessel.

In another aspect of the disclosure, there is provided a method of sugar extraction including producing a nanobubble solution; heating the nanobubble solution; and mixing the heated nanobubble solution with a starch source.

In a further aspect, the nanobubble solution is heated after being mixed with the starch source.

### DESCRIPTION OF THE DRAWINGS

The following figures illustrate various aspects and preferred and alternative embodiments of the disclosure.

FIG. 1 is a schematic diagram of apparatus for producing an alcoholic beverage;

FIG. 2 is a perspective view of one embodiment of a nanobubble generator;

FIG. 3a is a perspective view of a part of the nanobubble generator of FIG. 2;

FIG. 3b is a longitudinal cross-sectional view of the nanobubble generator of FIG. 2;

FIG. 4 is a side view of a treatment portion of the nanobubble generator;

FIG. 5 is a perspective view of the treatment portion of FIG. 4;

FIG. 6 is a front view of a disc-like element of the nanobubble generator;

FIG. 7 is an enlarged view of a longitudinal cross-section of the nanobubble generator;

FIG. 8 is a schematic diagram of a system for generating a nanobubble solution;

FIG. 9 is a schematic diagram of another embodiment of a system for generating a nanobubble solution;

FIG. 10 is a flowchart outlining a method of producing an alcoholic beverage with a nanobubble solution; and

FIGS. 11a to 11d are charts outlining experimental data.

### DETAILED DISCLOSURE

The disclosure is directed at a method and system for producing an alcoholic beverage. The method includes using a nanobubble solution, such as nanobubble water instead of regular water (such as well water) in the process. Use of the nanobubble solution was shown to increase the alcohol by volume (ABV) percentage of the resultant beverage by replacing the water with nanobubble water and using the same ingredients. Alternatively, a reduced amount of ingredients may be used to produce a similar ABV % using conventional processes.

In another aspect of the method, use of the nanobubble water also results in an increased level of sugar extraction during the production process. The sugar extraction also occurred in a shorter time frame than current methods of sugar extraction. This novel method of sugar extraction may also be considered for other applications where sugar production or extraction from a starch source is being performed or beneficial. Although described as being used in the process of producing an alcoholic beverage, the sugar extraction may also be used in other applications where sugar is being extracted from a starch source.

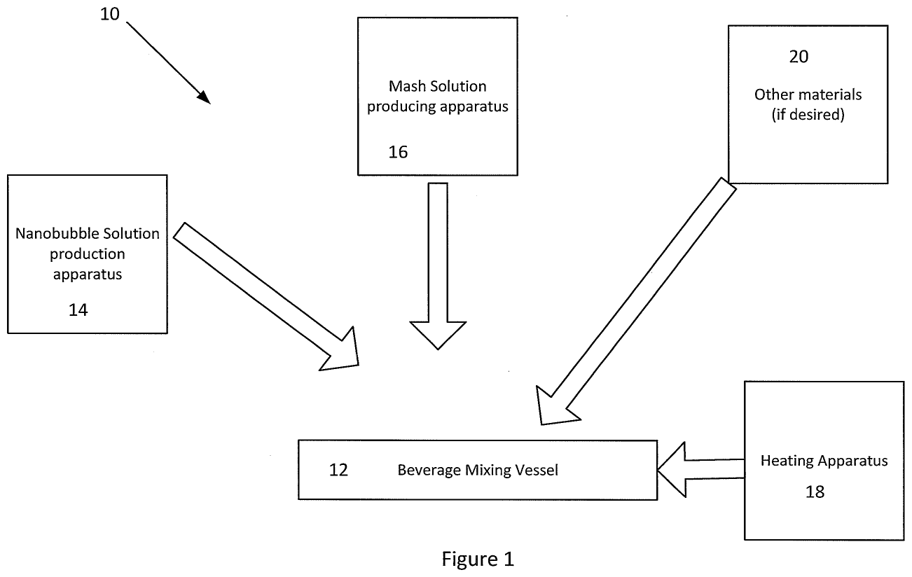

Turning to FIG. 1, a schematic diagram of apparatus for producing an alcoholic beverage is shown. The apparatus 10 includes a beverage mixing vessel 12 such as a keg, however, it will be understood that any container in which materials can be mixed is suitable. The beverage mixing vessel 12 may include apparatus to mix the ingredients within the vessel as the ingredients are being added in an automated or non-automated manner. Alternatively, the ingredients may be mixed manually.

The apparatus 10 further includes a nanobubble solution production apparatus 14 that generates or produces a nanobubble solution, such as nanobubble water, to be used in the alcoholic beverage production process. The apparatus 10 further includes an apparatus for producing and adding a mash solution 16 to the beverage mixing vessel 12 along with a heating apparatus 18 for heating the beverage mixing vessel, when, or if necessary.

The nanobubble solution production apparatus 14 may be constructed in a variety of different embodiments to create or generate nanobubbles in a liquid or a liquid solution. The nanobubble solution production apparatus may include a nanobubble generator or any other type of apparatus capable of generating nanobubbles in a liquid or liquid solution. In another embodiment, the apparatus 14 may be connected with a source of liquid. The system 10 may also include apparatus for adding other materials 20 to the beverage mixing vessel 12. These other materials may include materials to enhance or flavor the alcoholic beverage.

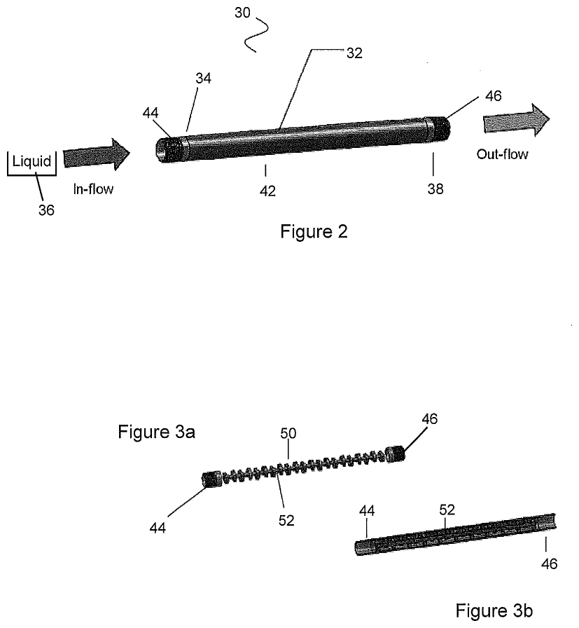

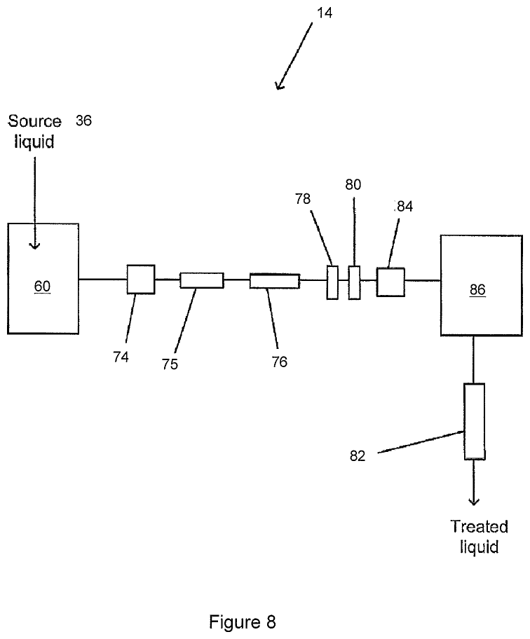

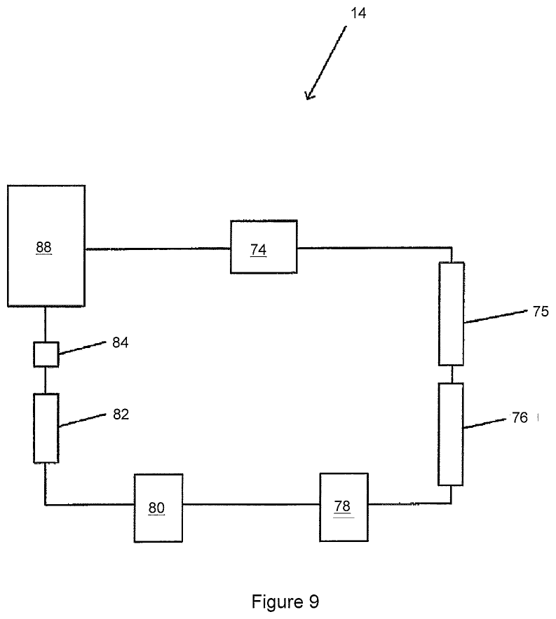

Turning to FIGS. 2 to 7, schematic diagrams of a nanobubble generator for use in the nanobubble solution production apparatus 14 is shown. The nanobubble generator 30 is used to assist in the generation of the nanobubble solution (nanobubble water) from a source liquid, such as, but not limited to, water.

As shown in FIG. 2, the nanobubble generator 30 may include a housing 32 having an inflow portion or end 34 for receiving a source solution or liquid (i.e. water) from a source 36, an outflow portion or end 38 for releasing the nanobubble solution 40 and a treatment portion or area 42 between the inflow end 34 and the outflow end 38 for treating the source liquid 36. The inflow end 34 and outflow end 38 may include a threaded boss 44 and 46, respectively. In a preferred embodiment, the housing 32 and bosses 44 and 46 are made of a substantially inert material, such as, but not limited to, polyvinyl chloride (PVC). In an embodiment, the housing 32 may take a substantially tubular form.

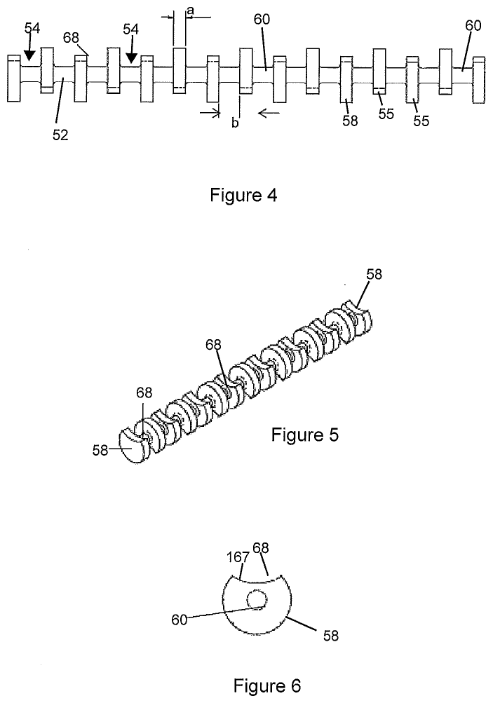

Turning to FIG. 3a, a perspective view of a treatment apparatus is shown. FIG. 3b is a section view of the nanobubble generator 30 with the treatment apparatus housed therein. The treatment apparatus 50, which can be seen as a nanobubble generating member, includes the bosses 44 and 46 at opposite ends of the treatment apparatus and a generally elongated member 52 between the two bosses 44 and 46. As can be seen in FIG. 3b, the elongated member 52 is preferably housed within the housing 32 with the bosses 44 and 46 extending out of the housing 32.

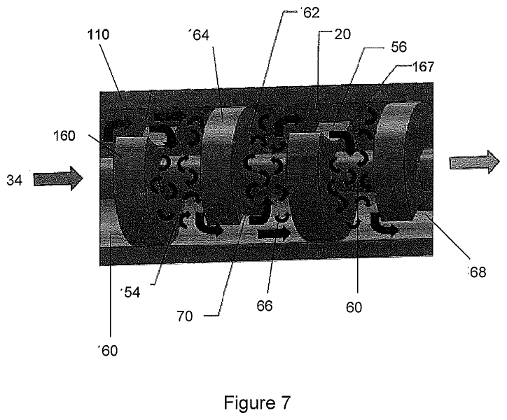

With reference to FIGS. 4 to 7, the treatment apparatus 50 of the nanobubble generator 30 may include a series of sequential cavitation zones 54 and shear surface planes 56. The series of sequential cavitation zones 54 and shear surface planes 56 may be enabled by having the generally elongated member 52 having a series of two or more spaced apart elements 58 which extend axially through the housing 32 and may be interposed between the inflow 34 and the outflow 38 ends, or portions of the nanobubble generator 30. In one embodiment, between two (2) and thirty (30) spaced apart elements 58 may be used while in another embodiment, more than thirty (30) spaced apart elements 58 may be used. It will be understood that any number of spaced apart elements 58 may be used.

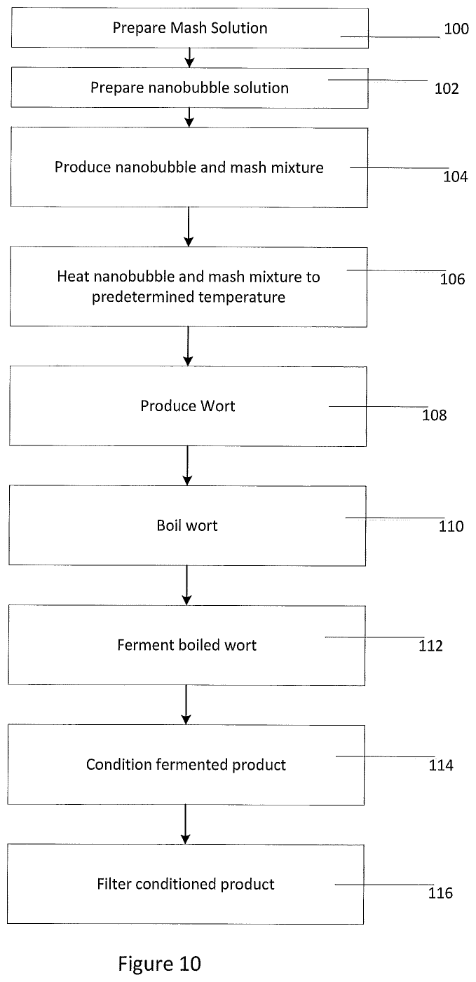

The elements 58, which in a preferred embodiment, are disc-shaped, may be supported upon or mounted on a central rod or shaft 60 of the elongated member 52. With reference to FIG. 7, each element 58 may include opposite walls 60 and 62 (also referred to as shear walls) and a peripheral or side wall 64. One shear wall 60 may face the inflow end and the opposite shear wall 62 may face the outflow end 38 of the nanobubble generator 10. The peripheral wall 64 may extend between opposite shear walls 60 and 62. The disc-like elements 58 may be held in spaced relation to each other and may be separated from one another by a space 66.

Furthermore, each element 58 is preferably formed with at least one groove or notch 68 extending downwards from its peripheral wall 64. Each groove or notch 68 may include edges or shear edges 70 and a shear surface plane 56 between the shear edges 70. The shear surface plane 56 may be viewed as a continuation of the peripheral wall 64 into the groove or grooves 68. The edges 70, which may have a scallop design, may be substantially sharp as to be able to shear the liquid passing through the nanobubble generator 30.

In one embodiment, the disc-like elements 58 may be laser cut and may be manufactured from a single metal. Preferably the disc-like elements may be made of a corrosion resistant metal. More preferably, the disc-like elements 58 may be made from stainless steel 300 series, such as 316L.

As illustrated in FIG. 4, in a preferred embodiment, a width of each disc-like element 58 can be seen as “a” and therefore a width of the shear plane surface is preferably about one half the distance “b” or space 66 between two consecutive disc-like elements 58.

As further illustrated in FIGS. 4 to 7, the axially successive discs 58 are arranged along the rod 60 with their notches or grooves circumferentially staggered in relation to one another. The elements 58 may be arranged on the rod 60 such that the notches 68 of adjacent elements 58 are in an alternating pattern. That is, if a notch in one disc-like element 58 is facing down, the notch in the following, or adjacent, disc-like element is facing up.

As shown in FIG. 7, each disc-like element 58 may be disposed substantially perpendicular to the flow of the liquid solution within the housing 32, such that the elements 58 may substantially block any direct fluid flow through the housing 32 and as a result the fluid flow is directed to pass through, over, or by, the notches, grooves or apertures 68 of the elements 58. Due to the alternating arrangement of the grooves 68, the fluid flow between the elements 58 is turbulent and by virtue of the differing cross-sectional areas of the grooves 68 in each element 58, the width of the elements, and the space 66 between the elements 58, the liquid is caused to accelerate and decelerate on its passage through the housing 32 to ensure a turbulent flow over the surfaces of the elements 58. The nanobubble generator may be unidirectional and unipositional as shown by the arrows in FIGS. 2 and 7.

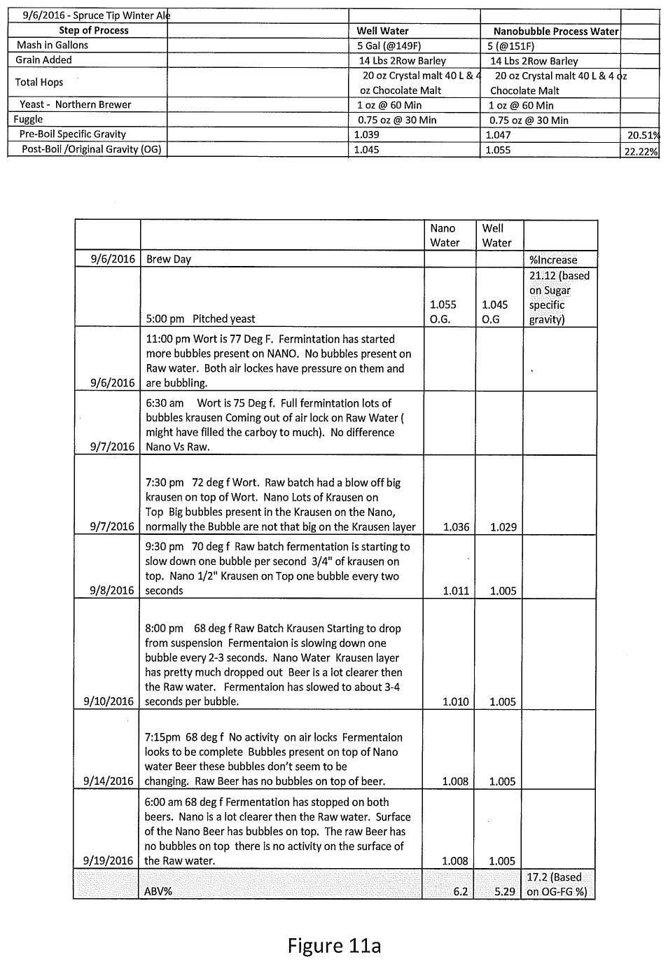

FIG. 8 shows a first embodiment of a nanobubble solution production apparatus 14 for producing nanobubbles in a liquid. The liquid is preferably provided by the liquid source 36. In one embodiment, the apparatus 14 may include an optional source liquid pre-treatment system 74, a first nanobubble generator 75, an optional high zeta potential crystal generator 76, an optional pre-filtration system 78, an optional at least one filtration device 80, and an optional second nanobubble generator 82. The apparatus 14 may also include a pump 84 and a storage container 86. The pre-treatment system 74, the first nanobubble generator 75, the zeta potential shift crystal generator 76, the pre-filtration system 78, the filtration device 80 and the second nanobubble generator 82 are preferably in liquid communication with one another and are connected by way of a conduit system. The conduit system may include, for example, pipes, hoses, tubes, channels, and the like.

The liquid for the source liquid 36, such as water, well water or tap water, is supplied from any suitable source (for example a faucet) and the liquid may be stored in a reservoir 88. Examples of the source reservoir 88 may include, but are not limited to, steam boilers, water heaters, cooling towers, drinking water tanks, industrial water supply reservoirs, and the like. Source liquid may be added continuously or intermittently to liquid reservoir 88. Alternatively, the liquid may be supplied continuously or intermittently from any source. The composition of source liquid may be tested and, if necessary, additional minerals and other constituents may be added to provide a sufficient source for generation of nanobubbles. The source liquid may also be treated, prior or subsequent being held in the reservoir 88 by pre-treatment system 74 to substantially remove unwanted contaminants that may interfere with the treatment process, such as, but not limited to, debris, oil-containing constituents, and the like.

In operation, the liquid solution preferably flows through either or both of the first and second nanobubble generators 75 and 82 with enough force and pressure to initiate an endothermic reaction to create the nanobubbles with paramagnetic attributes. The pump 84 may be used to generate this force and pressure. Although not shown, other pumps may be located within the apparatus 14 to assist in generating adequate pressure for passing the source liquid through either nanobubble generator. As such, the liquid solution may be actively pumped towards either nanobubble generator. The treated liquid 40 can then be released using a passive system, such as located in a plume to treat the water before a water turbine or propeller.

As shown in FIG. 8, before reaching the at least one filtration device 80, the treated liquid may optionally be passed through a zeta potential crystal generator 76. High zeta potential crystal generators are known in the art and generally useful for the prevention or reduction of scaling. The high zeta potential crystal generator 76 may increase zeta potential of crystals by electronically dispersing bacteria and mineral colloids in liquid systems, reducing or eliminating the threat of bio-fouling and scale and significantly reducing use of chemical additives.

As further shown in FIG. 8, after passage through the first nanobubble generator 75 and the optional high zeta potential crystal generator 76, and before reaching the optional filtration device 80, the liquid may optionally be passed through the pre-filtration system 78, wherein minerals, such as iron, sulphur, manganese, and the like are substantially removed from the treated source liquid. Pre-filtration system 78 can be, for example, a stainless steel mesh filter. If necessary, or desired, the liquid output of the first nanobubble generator 75 may be passed through the at least one filtration device 80. In a preferred embodiment, filtration device 80 reduces, substantially reduces or eliminates bacteria, viruses, cysts, and the like from the treated liquid. Any filtration devices known in the art may be used. Filtration device 80 may include, but is not limited to, particle filters, charcoal filters, reverse osmosis filters, active carbon filters, ceramic carbon filters, distiller filters, ionized filters, ion exchange filters, ultraviolet filters, back flush filters, magnetic filters, energetic filters, vortex filters, chemical oxidation filters, chemical addictive filters, Pi water filters, resin filters, membrane disc filters, microfiltration membrane filters, cellulose nitrate membrane filters, screen filters, sieve filters, or microporous filters, and combinations thereof. The treated and filtered liquid may be stored or distributed for use and consumption.

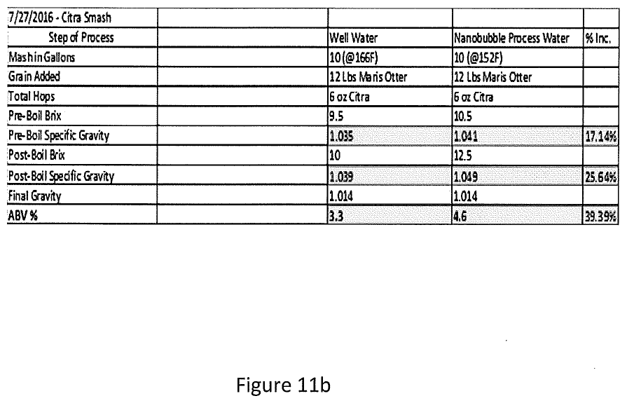

In the embodiment shown in FIG. 9, the pump 84 is provided downstream from the first nanobubble generator 75 and treated liquid 40 is released and distributed intermittently or continuously for various liquid system applications. As discussed above, the pump, or another pump, may be provided upstream from the first nanobubble generator 75.

The treated liquid, now having a high concentration of nanobubbles, may be distributed to and stored in a storage container 86, such as a reservoir or directly delivered to apparatus for alcoholic beverage production such as the mixing vessel 12 of FIG. 1. In this embodiment, before distribution of the stored treated liquid, the stored liquid may be passed through the second nanobubble generator 82, for generation of additional nanobubbles in the treated source liquid. The twice treated liquid may then be distributed for use in the alcoholic beverage production process. It should be understood that the system may include more than two nanobubble generators to further increase the number of nanobubbles within the liquid solution.

FIG. 9 illustrates another embodiment of a nanobubble solution production apparatus 14. The apparatus 14 is similar to the one shown in FIG. 8 and includes the reservoir 88 that store the liquid 40, an optional source liquid pre-treatment system 74, a first nanobubble generator 75, an optional high zeta potential crystal generator 76, an optional pre-filtration system 78, at least one optional filtration device 80 and an optional second nanobubble generator 82. The pre-treatment system 74, nanobubble generator 75, high zeta potential crystal generator 76, pre-filtration system 78, filtration device 80, and second nanobubble generator 82 are in liquid communication with one another and are connected by way of a circulating conduit system.

In the embodiment shown in FIG. 9, the conduit system connecting the components can be seen as being in a loop-like manner. Exemplary conduit systems may include, but are not limited to, pipes, hoses, tubes, channels, and the like, and may be exposed to the atmosphere or enclosed. The embodiment of FIG. 9 provides continuous or intermittent circulation of the source liquid through the components of the apparatus 14.

Continuous or intermittent treatment of the source liquid by the nanobubble generator system eventually arrives at a point in time where the entire volume of the source liquid within the apparatus 14 is treated by at least one of nanobubble generator 75 or nanobubble generator 82. In other words, the liquid within the apparatus 14 may eventually arrive at an equilibrium-like state, where the entire volume of the liquid within the apparatus 14 has been treated to generate nanobubbles.

While microbubbles tend to coalesce to form large buoyant bubbles which either float away or collapse under intense surface tension-derived pressure to the point that they vanish, the nanobubbles generated by either nanobubble generator 75 or 82 generally remain in suspension as the gases within them do not diffuse out.

Before passing through the optional filtration device 80, the treated liquid from the first nanobubble generator 75, containing a high concentration of nanobubbles, may optionally be passed through high zeta potential crystal generator 76 for generating high zeta potential crystals within the liquid to substantially remove minerals that can cause the formation of scale.

After passage through the high zeta potential crystal generator 76, the liquid may optionally be passed through pre-filtration system 78, wherein minerals, such as iron, sulphur, manganese, and the like are substantially removed from the treated source liquid before being passed through the filtration device 80.

The output from the filtration device 80 may then be passed through the optional second nanobubble generator 82 for generating additional nanobubbles. The continuous and intermittent treatment of the source liquid by one of the nanobubble generators 75 or 82 eventually results in the entire volume of the source liquid within the apparatus 14 being treated by one of the nanobubble generators 75 or 82.

The nanobubble solution produced with the methods and systems disclosed above may include a substantially high concentration of stable nanobubbles, or an enhanced concentration of stable nanobubbles.

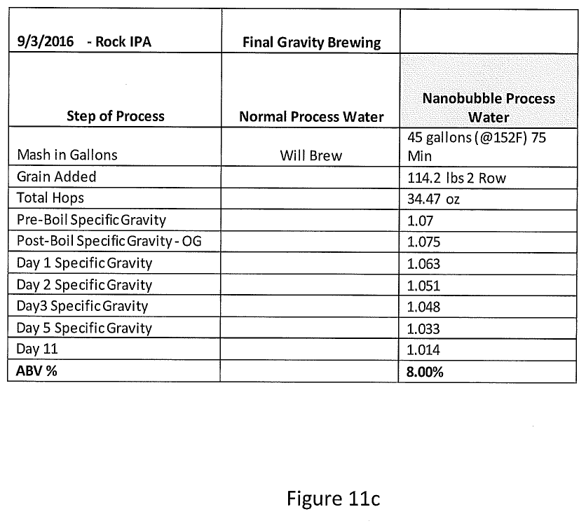

Turning to FIG. 10, a flowchart outlining a method of preparing an alcoholic beverage, in this case beer, is shown. Initially, a mash solution is produced or prepared 100. The mash solution can be produced using any known method. In one embodiment, the mash solution may be the combination of a mix of milled grain (typically malted barley with supplementary grains such as, for example, corn, sorghum, rye or wheat). The mash solution preferably includes a yeast as well. Depending on the type of yeast selected, the amount of sugar extracted from the mash solution may be controlled or pre-determined. This provides a benefit of being able to somewhat enable or control the sugar extraction process.

After the mash solution is produced, a nanobubble liquid or solution, such as a nanobubble water, is produced 102. In one embodiment, the nanobubble solution may be prepared using the nanobubble solution production apparatus 14 disclosed above. The nanobubble solution and the mash solution are then mixed together to produce a nanobubble and mash mixture 104. The mixture is then heated to a predetermined temperature 106 to extract the sugars from the mixture. This may also be seen as producing a wort or a method of sugar extraction. Alternatively, the nanobubble solution can be heated to a predetermined temperature and then mixed with the mash solution to extract the sugars.

Wort can be seen as the liquid extracted from the nanobubble and mash mixture during the heating process. Wort contains extracted sugars which assist in the alcoholic beverage producing process. In the current embodiment, the nanobubble solution, such as nanobubble water, is used in the production of the alcoholic beverage using known methods with regular water being replaced by the nanobubble water.

In current beer brewing processes, the sugar extraction (to produce the wort) is performed over the period of at least an hour, however, with the brewing process using nanobubble water, the sugar extraction was achieved in a shorter time frame. In the experiment, the nanobubble water sugar extraction was almost immediate after the heated nanobubble water was mixed with the mash solution.

After the sugar is extracted, the overall solution, is lautered 108 to separate the liquid (or wort) from the grains within the mash solution. This can be performed using any known method.

The wort is then boiled 110 in order to allow certain chemical reactions to take place in order to prepare the wort for fermentation 112. The fermented product can then be conditioned 114 and then filtered 116.

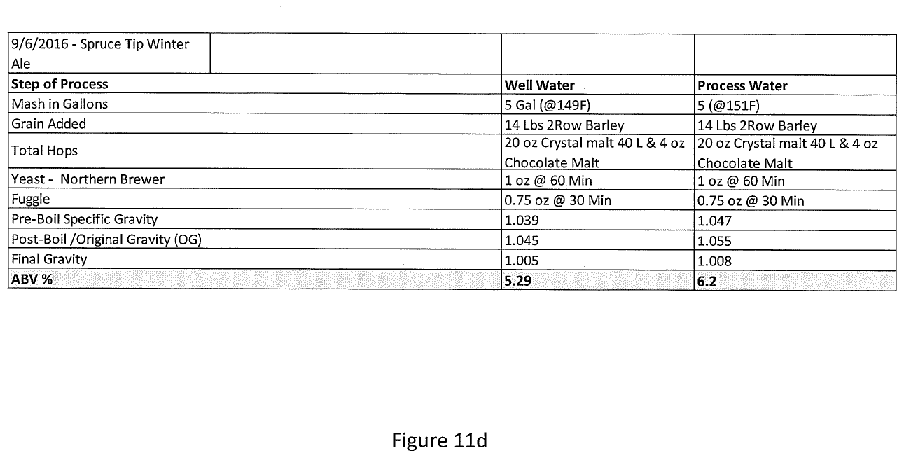

As noted, during experimentation and reflected in FIGS. 11a and 11b, when the heated nanobubble water is mixed with the mash solution, sugar extraction increased by about 21% based on sugar specific gravity (FIG. 11a) over what was expected if regular water or regular well water was used. In the controlled experiment, two alcoholic beverages were produced side-by-side with the primary difference being that one was produced with well water and the other with a water with nanobubbles, or nanobubble water.

For the experiment, two samples of water were obtained from the head of a water well with one of the samples then passed through the nanobubble solution production apparatus to generate nanobubble water. The water samples were then used to produce a gallon batch of an alcoholic beverage using similar or identical materials, recipes and procedures such as the one described with respect to FIG. 10.

As can be seen in the chart of FIG. 11a, the resultant alcoholic beverage using nanobubble water had an alcohol by volume (ABV) that was over 17% higher than the resultant alcoholic beverage producing using (regular) well water. Therefore, it can be seen that the use of a nanobubble water produces an alcoholic beverage that has a higher ABV % over an alcoholic beverage produced using regular water when using the similar or identical ingredients, recipe and procedures. The chart of FIG. 11a further reflects the difference in sugar content during the beverage production process.

In other experiments, it has been shown that use of a nanobubble water improves the sugar extraction process and increases the ABV % over the use of regular water with the same ingredients. As shown in FIG. 11b, the percentage increase during the sugar extraction process using the nanobubble water was over 25% when compared with the level of sugar extracted using regular water with the resulting alcoholic beverage having an ABV % of almost 40% more.

As shown in FIG. 11c, an alcohol content of 8% was achieved for the brewing of an Indian Pale Ale when using nanobubble water instead of regular water. In typical brewing processes, the alcohol content is between 4.8% and 5.2%.

While the results are directed towards the brewing of beers, it will be understood that the nanobubble solution may be used in the production or preparation of other alcoholic beverages likely with similar results and benefits. Another advantage of using nanobubble water instead of regular water is that the cleaning up of the brewing equipment is easier. Also, another advantage is that the resultant beverage has a higher clarity than the beverage produced with regular water.

While the above description provides examples of one or more apparatus, methods, or systems, it will be appreciated that other apparatus, methods, or systems may be within the scope of the claims as interpreted by one of skill in the art.

What is claimed is:

1. A method of producing an alcoholic beverage comprising:
generating a nanobubble solution;
mixing the nanobubble solution with a mash solution to produce a nanobubble and mash mixture;
lautering the nanobubble and mash mixture to produce a wort;
boiling the wort;
fermenting the boiled wort;
conditioning the fermented mixture; and
filtering the conditioned mixture.

2. The method of claim 1 wherein generating a nanonbubble solution comprises:
passing a liquid through a nanobubble generating apparatus.

3. The method of claim 2 wherein the liquid is water.

4. The method of claim 1 further comprising heating the nanobubble solution before mixing the nanobubble solution with the mash solution.

5. The method of claim 1 further comprising:
heating the nanobubble and mash mixture prior to lautering the wort.

6. The method of claim 1 wherein lautering comprises:
separating grains from the wort.

7. Apparatus for producing an alcoholic beverage comprising:
a nanobubble solution producing apparatus;
an apparatus for providing a mash solution; and
a mixing vessel for mixing the nanobubble solution and the mash solution.

8. The apparatus of claim 7 wherein the nanobubble solution producing apparatus comprises:
a nanobubble generator.

9. The apparatus of claim 8 wherein the nanobubble solution production apparatus further comprises a liquid source connected to an inflow end of the nanobubble generator.

10. The apparatus of claim 9 wherein the nanobubble solution production apparatus further comprises a reservoir for collecting the nanobubble solution at an outflow end of the nanobubble generator.

11. The apparatus of claim 7 further comprising a heating apparatus for heating the mixing vessel.

12. A method of sugar extraction comprising:
producing a nanobubble solution;
heating the nanobubble solution; and
mixing the heated nanobubble solution with a starch source.

13. The method of claim 12 wherein the nanobubble solution is heated after being mixed with the starch source.
